(19) United States
(12) Patent Application Publication
(10) Pub. No.: US 2017/0321009 A1
(43) Pub. Date: Nov. 9, 2017

(54) SEMI-AROMATIC POLYAMIDE PREPARATION METHOD

(71) Applicant: ARKEMA FRANCE, Colombes (FR)

(72) Inventors: Nicolas ALZONNE, Rouge Perriers (FR); Thierry BRIFFAUD, Bernay (FR)

(73) Assignee: ARKEMA FRANCE, Colombes (FR)

(21) Appl. No.: 15/535,269

(22) PCT Filed: Dec. 9, 2015
(86) PCT No.: PCT/FR2015/053389

§ 371 Date: Jun. 12, 2017

(30) Foreign Application Priority Data
Dec. 12, 2014 (FR) 1462304

(51) Int. Cl. C08G 69/04; C08G 69/36

(52) U.S. Cl. CPC C08G 69/04; C08G 69/36

(57) ABSTRACT

An industrial method for preparing a semi-aromatic copolyamide having a general formula A/10.T, wherein: A denotes a unit obtained by polycondensing a lactam or a C₉-C₁₂ amino acid; and 10.T denotes a unit obtained by polycondensing 1.10-decanediamine and terephtalic acid. The method includes a step for polycondensing the comonomers, the amino acid or the lactam, 1.10-decanediamine and terephtalic acid in the presence of at least one C₁-C₇ linear aliphatic acid. The level of foaming in a reactor is substantially reduced, during the polycondensation step, in relation to the level observed without C₁-C₇ linear aliphatic acid.

The present invention relates to a process for preparing a semiaromatic copolyamide by implementing a specific aliphatic acid, and also to the use of this acid as a chain limiter for the semiaromatic copolyamide and to the use of the copolyamide, The invention also relates to a composition comprising such a copolyamide and also to the uses of this composition.

It is known practice to use stearic acid as a chain limiter in the synthesis of semiaromatic polyamides. Specifically, polyamide synthesis is performed by polycondensation of a diacid and of a diamine, an amino acid or a lactam. Thus, the amine functions react with the acid functions to form the amide group. In order to better control this polycondensation, it is known practice to add to the reaction medium a monocarboxylic acid which reacts with the amine functions present in the medium and thus blocks the polycondensation.

It is known practice to use monocarboxylic acids, such as stearic acid or benzoic acid, for the synthesis of semiaromatic polyamide, in particular of the polyamide PA 11/10.T, i.e. the polyamide derived from the polycondensation of 11 -aminoundecanoic acid, 1,10-decanediamine and terephthalic acid. Now, the formation of foam in large amount and especially of stearic acid has been observed in the industrial synthesis of this copolyamide. Despite the addition of an antifoam to the reaction medium, an increase in the level of the product is observed in the reactor. As a result, to avoid entraining matter or its solidification in the top of the reactor, it is necessary to reduce the total feedstock introduced.

Thus, there is a real need to find a synthetic process that does not lead to the formation of foam in the reaction medium. The Applicant has found, surprisingly, that the use of a linear C₁-C₇ aliphatic acid as chain limiter, contrary to fatty acids and aromatic carboxylic acids, can prevent this phenomenon of foam and can thus avoid the use of an antifoam in the course of synthetic process.

Consequently, the invention relates to the process for preparing a semiaromatic copolyamide comprising at least two units corresponding to the following general formula A/10.T in which
A denotes a unit obtained from the polycondensation of a lactam or of a C₉-C₁₂ amino acid,
10.T denotes a unit obtained from the poIycondensation of 1,10-decanediamine and terephthalic acid.
   characterized in that it comprises a step of polycondensation of the comonomers: the amino acid or the lactam, 1,10-decanediamine and terephthalic acid, in the presence of at least one linear C₁-C₇ aliphatic acid, the level of foaming in the reactor being substantially reduced relative to the level observed without said linear aliphatic acid.

A subject of the invention is also the use of a linear C₁-C₇ aliphatic acid as a chain limiter in the synthesis of the copolyamide as defined above for substantially reducing the level of foaming during the polycondensation of a semiaromatic copolyamide in a reactor.

Other characteristics, aspects and advantages of the present invention will emerge even more clearly on reading the description and the examples that follow.

The Process

The invention relates to a process for preparing a semiaromatic copolyamide comprising at least two units corresponding to the following general formula A/10.T in which
A denotes a unit obtained from the polycondensation of a lactam or of a C₉-C₁₂ amino acid,
10.T denotes a unit obtained from the polycondensation of 1,10-decanediamine and terephthalic acid,
   characterized in that it comprises a step of polycondensation of the comonomers: the amino acid or the lactam, 1,10-decanediamine and terephthalic acid, in the presence of at least one linear C₁-C₇ aliphatic acid, the level of foaming in the reactor being substantially reduced during the polycondensation step relative to the level observed without the linear C₁-C₇ aliphatic acid.

The inventors have thus found that the use of a short-chain (C₁-C₇) linear C₁-C₇ aliphatic acid, as a chain limiter, in particular acetic acid, allows the industrial preparation of a serniaromatic copolyamide by substantially reducing the level of foaming in the reactor during the step of polycondensation of the comonomers relative to the level observed without the linear C₁-C₇ aliphatic acid.

Advantageously, the short-chain (C₁-C₇) linear C₁-C₇ aliphatic acid is a monoacid.

The term “substantially” should be understood as meaning a reduction of at least 10% in the level of foaming relative to the level observed without the linear C₁-C₇ aliphatic acid. The use of a linear aliphatic acid limits the phenomenon of foaming and thus prevents the entrainment of matter or its solidification in the top of the reactor and thus avoids the need to reduce the total feedstock of comonomers introduced, thus allowing a saving in time and cost during the preparation of the same amount of semiaromatic copolyamide.

Consequently, the presence of a linear aliphatic acid in said process makes it possible to perform the process on a large reactor size, in any event on a size greater than that used in the absence of said linear aliphatic acid even in the presence of an antifoam.

Thus, for example, for a reactor with a capacity of 1 ton, a reduction of at least 10% in the level of foaming in said reactor makes it possible to introduce therein at least 100 kg more of monomers.

In one embodiment, the polycondensation step is performed in the absence of antifoam.

Another advantage of the invention is thus the possible suppression of the use of an antifoam, thus allowing a saving in the cost of the process.

In another embodiment, an antifoam is also used, especially in a weight proportion relative to the total weight of all the constituents introduced into the reactor of from 1 to 500 ppm, in particular from 10 to 250 ppm and more particularly from 10 to 50 ppm.

The antifoams usually used are optionally based on silicon, especially crude silicone oils, or in the form of aqueous dispersions, such as Silikonol 1000, Tegiloxan AV1000, Silcolapse RG22 or EFKA™ 2720 (BASF).

Advantageously, the level of foaming is reduced by at least 10%, especially by at least 20%, in particular by 20% to about 30% relative to the level observed without the linear C₁-C₇ aliphatic acid. As a function of the presence or absence of antifoam, the observed reduction in the level of foaming is more or less pronounced, but it is in any case at least 10% in the absence of antifoam.

All the percentages of reduction of foaming in the description are given relative to the level observed without the linear C₁-C₇ aliphatic acid, irrespective of the presence or absence of antifoam.

In one embodiment, said polycondensation step is performed in a single step in the same reactor at a temperature from 200 to 300° C., in particular above the melting point of the semiaromatic copolyamide, at a pressure which may rise up to 30 bar and gradually reduced down to a pressure less than or equal to atmospheric pressure so as to complete the polymerization.

The reaction temperature in this polycondensation step must be higher than the melting point of the semiaromatic copolyamide in order for stirring to he able to be performed.

Said reaction thus produces as intermediates semiaromatic oligomers, which, by condensation with each other, lead directly to the semiaromatic copolyamide in the same reactor.

The level of foaming is thus lowered by at least 10%, especially by at least 20% and in particular by 20% to about 30% in said reactor.

Optionally, the polymer may be removed from said reactor at a pressure above atmospheric pressure. The polymerization may then be optionally completed by a step of extrusion at a temperature above the melting point, or by a step of heating at a temperature below the melting point of the copolyamide according to a “solid-state polymerization” process.

In another embodiment, the polycondensation step is performed in three steps and comprises the following steps:
a. a first step of pre-polymerization in a concentrator by heating the comonomers in the presence of said at least aliphatic acid, at a temperature of from 200° C. to 300° C., especially at a pressure of from 20 to 30 bar, to obtain a semiaromatic prepolymer, said temperature especially being a temperature above the melting point of the prepolymer;
b. a second step of transfer of the prepolymer from the concentrator to a polymerizer at a temperature of from 220 to 280° C. at a pressure from 10 to 20 bar;
c. a third step of polymerization by heating at a temperature of from 200 to 300° C. at a pressure which may range up to 30 bar, gradually reduced down to a pressure less than or equal to atmospheric pressure so as to complete the polymerization to obtain said copolyamide, said temperature especially being a temperature above the melting point of said copolyamide.

Optionally, the polymer after completion of the polymerization in step c. may be removed from said polymerizer at a pressure above atmospheric pressure. The polymerization may then be optionally completed, by a step of extrusion at a temperature above the melting point, or by a step of heating at a temperature below the melting point of the copolyamide according to a “solid-state polymerization” process.

The first step corresponds to the formation in the concentrator of the semiaromatic prepolymer with a molecular mass (Mn) from about 1000 to 8000 as determined by NMR.

The second step corresponds to the transfer of the semiaromatic prepolymer into a polymerizer. As a general rule, this step is accompanied by a pressure reduction, and the semiaromatic copolyamide is then formed in the third step by condensation of the prepolymer on itself by heating especially above the melting point of the polymer. Advantageously, the heating temperature to obtain the semiaromatic copolyamide in this third step is 10° C. higher than the melting point of said copolyamide.

In one embodiment, the reduction in the level of foaming takes place at least during the first step, in the concentrator, and is in particular at least 10%, especially at least 20%, in particular from 20% to about 30%.

Advantageously, the reduction in the level of foaming takes place during the first step in the concentrator, and is in particular at least 10%, especially at least 20%, in particular from 20% to about 30%, and also during the third step in the polymerizer, and is in particular at least 10%, especially at least 19%, in particular from 19% to about 30%.

Advantageously, the linear C₁-C₇ aliphatic acid is in a weight proportion relative to the total weight of all the constituents introduced into the reactor of from 0.1% to 3%, in particular from 0.1 to 1%.

Preferably, the linear C₁-C₇ aliphatic acid is chosen from acetic acid, propanoic acid and butanoic acid, and a mixture thereof. Preferentially, acetic acid or propanoic acid is used, in particular acetic acid.

As more particularly regards the meaning of the unit A, when, A represents an amino acid, it may be chosen from 9-aminononanoic acid (A=9), 10-aminodecanoic acid (A=10), 12-aminododecanoic acid (A=12) and 11-aminoundecanoic acid (A=11) and also derivatives thereof, especially N-heptyl-11-aminoundecanoic acid.

Instead of one amino acid, a mixture of two, three or more amino acids may also be envisaged. However, the copolyamides formed would then comprise three, four, or more units, respectively.

When A represents a lactam, it assay be chosen from pelargolactam, decanolactam, undecanolactam and lauryllactam (A=12).

Preferably, A denotes a unit obtained from a monomer chosen from 11-aminoundecanoic acid (denoted 11), 12-aminododecanoic acid (denoted 12) and lauryllactam (denoted L12).

Preferably, A denotes 11-aminoundecanoic acid (denoted 11).

The invention also relates to the semiaromatic copolyamides that may be obtained via the industrial process defined above, especially to 11/10.T.

A subject of the invention is also the use of a linear C₁-C₇ aliphatic acid as a chain limiter in the synthesis of the copolyamide as defined above, for substantially reducing the level of foaming in a reactor during the step of polycondensation of the comonomers relative to the level observed without the linear C₁-C₇ aliphatic acid.

Advantageously, the linear C₁-C₇ aliphatic acid is a monoacid.

Advantageously, the use of a linear C₁-C₇ aliphatic acid defined above is performed in the absence of antifoam.

Advantageously, the linear C₁-C₇ aliphatic acid may be used in a process in which the polycondensation step is performed in the same reactor in a single step as defined above, or in a process in which the polycondensation step is performed in three steps as defined above.

Advantageously, the level of foaming observed, with the use of a linear C₁-C₇ aliphatic acid defined above, is reduced by at least 10%, especially by at least 20%, in particular by 20% to about 30% relative to the level observed without the linear C₁-C₇ aliphatic acid.

Advantageously, the linear C₁-C₇ aliphatic acid is in a weight proportion relative to the total weight of all the constituents introduced into the reactor of from 0.1% to 3%, in particular from 0.1 to 1%.

Advantageously, the linear C₁-C₇ aliphatic acid is chosen from acetic acid and propanoic acid, and in particular the linear C₁-C₇ aliphatic acid is acetic acid.

Advantageously, the use of a linear C₁-C₇ aliphatic acid defined above is performed with a copolyamide 11/10.T.

The examples that follow serve to illustrate the invention without, however, being limiting in nature.

### EXAMPLES

Comparison of the level of foaming during the preparation of a PA 11/10T (0.7/1 mol %) in the presence of stearic acid or acetic acid in a process comprising a polycondensation step in three steps.

The comonomers comprising stearic acid or acetic acid, sodium hypophosphite, Silikonol 1000 and water in proportions as defined in Table I below are introduced into the concentrator and heated at a temperature from 200 to 300° C. at a pressure from 20 to 30 bar to form a prepolymer, and the prepolymer is then transferred into a polymerizer and the prepolymer is then heated in the polymerizer at a temperature from 200° C. to 300° C. at a pressure of 20 to 30 bar, and the pressure is then gradually reduced to atmospheric pressure.

| | Comparative example: | Example 1 |
|---|---|---|
| | With stearic acid | With acetic acid |
| Components | Mass (kg) | Mass (kg) |
| 1,10-Decanediamine | 129.7 | 129.7 |
| 11-Aminoundecanoic | 100 | 100 |
| acid | | |
| Terephthalic acid | 120.8 | 120.8 |
| Acetic acid | — | 2.5 |
| Stearic acid | 8.3 | — |
| 60% NaH₂PO₂ | 1.4 | 1.4 |
| Silikonol ® 1000 | 0.07 | 0.07 |
| Water | 73 | 73 |

The level of foaming is determined by means of a detector for measuring the maximum level of the reaction medium in the concentrator and in the polymerizer for each compound (Example 1 and comparative example).

| | Level in the | Level in the |
|---|---|---|
| | concentrator | polymerizer |
| | (% of the maximum | (% of the maximum |
| | level of the reactor) | level of the reactor) |
| Comparative example: | 70.02 | 71.03 |
| With stearic acid | (n = 20) | (n = 24) |
| Example 1 | 54.17 | 57.16 |
| With acetic acid | (n = 6) | (n = 6) |
| % of decrease | 22.64% | 19.5% |
| in foaming | | |

The same type of result was observed with a one-step process in a single reactor.

1. An industrial process for preparing a semiaromatic copolyamide of general formula A/10.T in which
A denotes a unit obtained from the polycondensation of a lactam or of a C₉-C₁₂ amino acid,
10.T denotes a unit obtained from the polycondensation of 1,10-decanediamine and terephthalic acid,
wherein the process comprises a step of polycondensation of the comonomers: the amino acid or the lactam, 1,10-decanediamine and terephthalic acid, in the presence of at least one linear C₁-C₇ aliphatic acid in a reactor, the level of foaming in the reactor being substantially reduced during the polycondensation step relative to the level observed without the linear C₁-C₇ aliphatic acid.

2. The industrial preparation process as claimed in claim 1, in which the polycondensation step is performed in the absence of antifoam.

3. The process as claimed in claim 1, in which the level of foaming is reduced by at least 10% relative to the level observed without the linear C₁-C₇ aliphatic acid.

4. The process as claimed in claim 1, in which the polycondensation step is performed in a single step in the same reactor at a temperature from 200 to 300° C., at a pressure which may rise up to 30 bar, and gradually reduced down to a pressure less than or equal to atmospheric pressure so as to complete the polymerization.

5. The process as claimed in claim 1, in which the polycondensation step is performed in three steps and comprises the following steps:
a. a first step of pre-polymerization in a concentrator by heating the comonomers in the presence of said at least aliphatic acid, at a temperature of from 200° C. to 300° C., at a pressure of from 20 to 30 bar to obtain a prepolymer, said temperature being a temperature above the melting point of the prepolymer;
b. a second step of transfer of the prepolymer from the concentrator to a polymerizer at a temperature of from 220 to 280° C. at a pressure from 10 to 20 bar;
c. a third step of polymerization by heating at a temperature of from 200 to 300° C. at a pressure which may range up to 30 bar, then reduced down to a pressure less than or equal to atmospheric pressure so as to complete the polymerization to obtain said copolyamide, said temperature being a temperature above the melting point of said copolyamide.

6. The process as claimed in claim 5, in which the reduction in the level of foaming takes place at least during the first step, in the concentrator.

7. The industrial preparation process as claimed in claim 1, in which the linear aliphatic acid is chosen from propanoic acid and acetic acid.

8. The industrial preparation process as claimed in claim 1, in which said semiaromatic copolyamide is 11/10.T.

9. A semiaromatic copolyamide which may be obtained via the process as defined in claim 1.

10. The semiaromatic copolyamide as claimed in claim 9, in which said copolyamide is 11/10.T.

11. A method for substantially reducing the level of foaming in a reactor during the step of polycondensation of the comonomers of a semiaromatic copolyamide as defined in claim 1, relative to the level observed without the linear C₁-C₇ aliphatic acid.

12. The method as claimed in claim 11, in which the polycondensation step is performed in the absence of antifoam.

13. The method as claimed in claim 11, in which the level of foaming is reduced by at least 10% relative to the level observed without the linear C₁-C₇ aliphatic acid.

14. The method as claimed in claim 11, in which the linear aliphatic acid is acetic acid.

15. The method as claimed in claim 11, in which said semiaromatic copolyamide is 11/10.T.
